(19) United States
(12) Patent Application Publication
(10) Pub. No.: US 2026/0332044 A1
(43) Pub. Date: Oct. 22, 2026

(54) VOLTAGE GENERATING DEVICE AND CHARGE PUMP CIRCUIT THEREOF

(71) Applicant: Winbond Electronics Corp., Taichung City (TW)

(72) Inventor: Chung-Zen Chen, HsinChu (TW)

(73) Assignee: Winbond Electronics Corp., Taichung City (TW)

(21) Appl. No.: 19/577,407

(22) Filed: Mar. 25, 2026

(30) Foreign Application Priority Data
Apr. 18, 2025 (TW) 114114833

(51) Int. Cl. H02M 3/07

(52) U.S. Cl. CPC H02M 3/07

(57) ABSTRACT

A voltage generating device and a charge pump circuit thereof are provided. The charge pump circuit includes multiple charge pump units coupled in series, a first capacitor, and a voltage-divided capacitor. The charge pump units include a first charge pump unit and a second charge pump unit. The first charge pump unit is configured to generate a first boosted voltage, and the second charge pump unit is configured to generate a second boosted voltage. The first capacitor is coupled between the first boosted voltage and a first clock signal. The voltage-divided capacitor is coupled between the second boosted voltage and a second clock signal and receives a bias voltage, wherein the bias voltage is less than the second boosted voltage and greater than a reference ground voltage.

### CROSS-REFERENCE TO RELATED APPLICATION

This application claims the priority benefit of Taiwan application serial no. 114114833, filed on April 18, 2025. The entirety of the above-mentioned patent application is hereby incorporated by reference herein and made a part of this specification.

### BACKGROUND

### Technical Field

The disclosure relates to a voltage generating device and a charge pump circuit thereof, and more particularly to a more sustainable internal voltage generating device and a charge pump circuit thereof.

### Description of Related Art

In an electronic device, an internal voltage generating device is usually disposed to generate an internal voltage. For example, in a flash memory, an internal voltage generating device having a charge pump circuit is usually disposed to generate a programming voltage higher than an operating voltage.

A conventional voltage generating device includes a multi-stage charge pump unit and a capacitor at an output terminal. A boosted voltage may be generated by boosting a reference voltage. As the voltage boosting operation proceeds, a later-stage charge pump unit may generate a higher boosted voltage. When the voltage boosting operation of the charge pump unit is stopped, one terminal of a capacitor corresponding to the later-stage charge pump unit may receive a higher boosted voltage, and the other terminal of the capacitor may receive a lower reference voltage or a reference ground voltage. This way, a high voltage difference will be applied to both terminals of the capacitor, resulting in a reduced service life of the capacitor and thereby affecting the service life of the voltage generating device and an overall system.

### SUMMARY

The disclosure provides a voltage generating device and a charge pump circuit thereof. A high voltage difference borne by two terminals of a capacitor in a charge pump unit may be avoided.

A charge pump circuit of the disclosure includes a plurality of charge pump units coupled in series, a first capacitor, and a voltage-divided capacitor. The charge pump units include a first charge pump unit and a second charge pump unit. The first charge pump unit is configured to generate a first boosted voltage, and the second charge pump unit is configured to generate a second boosted voltage. The first capacitor is coupled between the first boosted voltage and a first clock signal. The voltage-divided capacitor is coupled between the second boosted voltage and a second clock signal and receives a bias voltage. The bias voltage is less than the second boosted voltage and greater than a reference ground voltage.

A voltage generating device of the disclosure includes the charge pump circuit and an enable signal generator. The charge pump circuit is configured to provide an output boosted voltage. The enable signal generator is coupled to the voltage generating device and is configured to generate an enable signal configured to disable or enable the charge pump circuit according to a comparison result between the output boosted voltage and a reference voltage.

Based on the above, in the charge pump circuit of the disclosure, an output terminal of one or more stages of the charge pump units is coupled to the voltage-divided capacitor. The voltage-divided capacitor receives a bias voltage that is less than the second boosted voltage and greater than the reference ground voltage. This way, a high voltage difference across the two terminals of the capacitor may be avoided, thereby effectively extending the service life of the capacitor and achieving the requirements of green semiconductors.

### BRIEF DESCRIPTION OF THE DRAWINGS

FIG. 1 is a schematic diagram of a charge pump circuit of an embodiment of the disclosure.

FIG. 2 is a schematic diagram of a clock signal generator of the embodiment of the disclosure.

FIGS. 3A and 3B are waveform diagrams of an operation of the charge pump circuit of the embodiment of the disclosure.

FIGS. 4A to 4C are schematic diagrams of a charge pump circuit of another embodiment of the disclosure.

FIGS. 5A and 5B are schematic diagrams of voltage generating devices of different embodiments of the disclosure.

### DESCRIPTION OF THE EMBODIMENTS

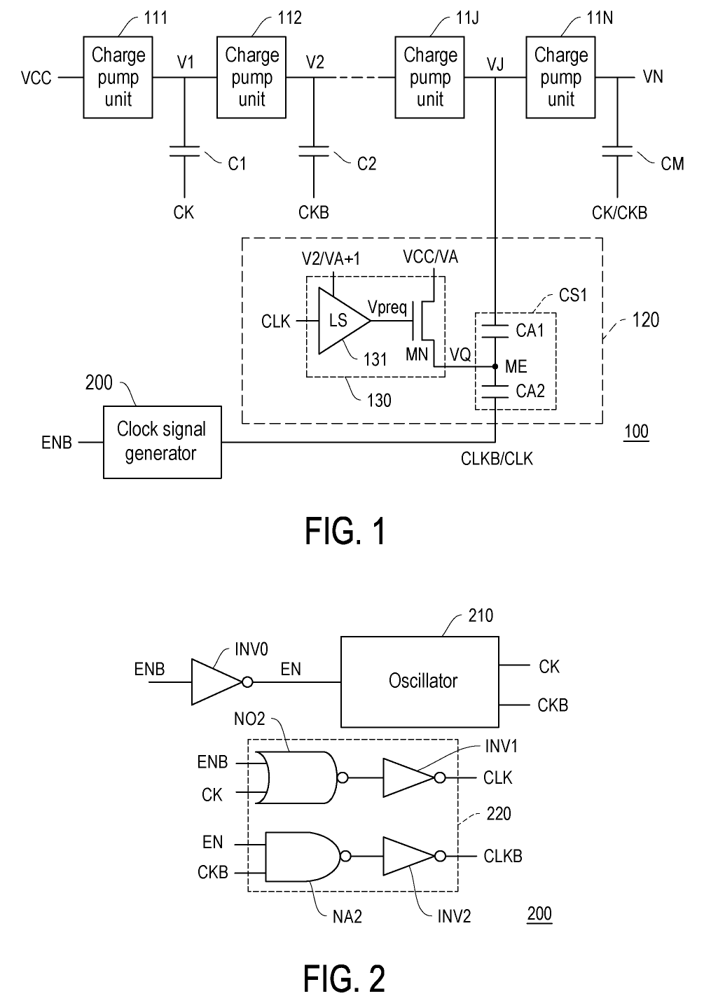

Referring to FIG. 1, a charge pump circuit 100 in this embodiment includes a plurality of charge pump units 111 to 11N, a plurality of capacitors C1 to CM, and a voltage-divided capacitor 120. The voltage-divided capacitor 120 may include a capacitor string CS1 and a bias generator 130. The charge pump units 111 to 11N are coupled in series. A first-stage charge pump unit 111 receives a reference voltage VCC and performs a charge pump operation on the reference voltage VCC to generate a boosted voltage V1. A second-stage charge pump unit 112 receives the boosted voltage V1 and increases the boosted voltage V1 to generate a boosted voltage V2. And so on, the charge pump units 111 to 11N may perform stage-by-stage charge pump operations on the reference voltage VCC to respectively generate sequentially increased boosted voltages V1 to VN. In this embodiment, a number of the charge pump units 111 to 11N may be N, and N may be a positive integer greater than 1. The reference voltage VCC may be a power supply voltage.

In this embodiment, a number of the capacitors C1 to CM may be M, and M is less than N. For example, N-M=1, but the disclosure is not limited thereto. A first terminal of each of the capacitors C1 to CM is respectively coupled to an output terminal of a corresponding one of the charge pump units 111 to 11N except the charge pump unit 11J. A second terminal of each of the capacitors C1 to CM receives a clock signal CK or a clock signal CKB. The clock signal CK and the clock signal CKB may be periodic signals having opposite phases.

A first terminal of the capacitor string CS1 is coupled to an output terminal of the corresponding Jth stage charge pump unit 11J to receive a boosted voltage VJ. A second terminal of the capacitor string CS1 receives a clock signal CLKB or CLK. The clock signal CLK and the clock signal CLKB may be periodic signals having opposite phases, or may be signals having different voltage values. The capacitor string CS1 may include a capacitor CA1 and a capacitor CA2 coupled in series. A first terminal of the capacitor CA1 is the first terminal of the capacitor string CS1. A second terminal of the capacitor CA2 is the second terminal of the capacitor string CS1. The capacitor string CS1 may have a bias node ME located between a second terminal of the capacitor CA1 and a first terminal of the capacitor CA2. In this embodiment, a number of the capacitor string CS1 may be 1 (i.e., equal to N-M), but the disclosure is not limited thereto.

On the other hand, a bias generator 130 is coupled to the capacitor string CS1 and is configured to provide a bias voltage VQ to a bias node ME of the capacitor string CS1. In this embodiment, the bias generator 130 may include a level shifter (LS) 131 and a transistor MN. A control terminal of the transistor MN is coupled to the level shifter 131 to receive a control voltage Vpreq. A first terminal of the transistor MN receives a second input voltage that is less than a boosted voltage VJ-1, for example, a reference voltage VCC or a first preceding-stage boosted voltage VA. A second terminal of the transistor MN is coupled to the bias node ME of the capacitor string CS1 to provide the bias voltage VQ. The first preceding-stage boosted voltage VA may be a boosted voltage generated by the Ath stage charge pump unit 11A, and A is a positive integer less than J-1, for example, V1.

The level shifter 131 may receive a first input voltage that is greater than the second input voltage received by the first terminal of the transistor MN and less than the boosted voltage VJ. For example, when the second input voltage is the reference voltage VCC, the first input voltage may be the boosted voltage V2. When the second input voltage is the first preceding-stage boosted voltage VA, the first input voltage may be a second preceding-stage boosted voltage VA+1. The second preceding-stage boosted voltage VA+1 may be generated by the (A+1)th stage charge pump unit 11A+1. Specifically, the level shifter 131 may receive a clock signal CLK and perform a voltage shifting operation on the clock signal CLK based on the received input voltage (the boosted voltage V2 or the second preceding-stage boosted voltage VA+1) to generate the control voltage Vpreq. The transistor MN may provide the reference voltage VCC or the first preceding-stage boosted voltage VA according to the control voltage Vpreq to generate the bias voltage VQ.

It should be noted that, in this embodiment, by providing the bias voltage VQ to the bias node ME of the capacitor string CS1 through the bias generator 130, a voltage difference borne by two terminals of the capacitor CA1 may be equal to VJ-VQ, and a maximum voltage difference borne by two terminals of the capacitor CA2 may be equal to VQ-VSS, wherein VSS is a reference ground voltage. This way, the voltage difference borne by the two terminals of each of the capacitors CA1 and CA2 may be less than VJ, which helps to improve the service life of the capacitors CA1 and CA2 and extend a life cycle of the charge pump circuit 100. Incidentally, in this embodiment, an equivalent capacitance value of the capacitor string CS1 may be equal to C_{CA1}*C_{CA2}/(C_{CA1}+C_{CA2}), wherein C_{CA1} is a capacitance value of the capacitor CA1, and C_{CA2} is a capacitance value of the capacitor CA2.

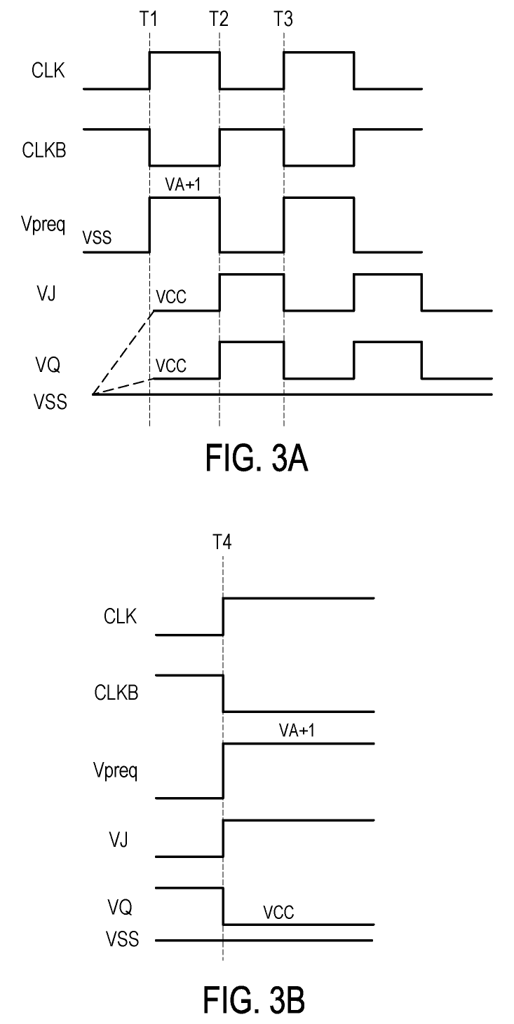

The charge pump circuit in this embodiment may further include a clock signal generator 200 configured to generate the clock signals CLK/CLKB. As shown in FIG. 2, the clock signal generator 200 may include an oscillator 210 and a logic circuit 220. The oscillator 210 is coupled to an output terminal of an inverter INV0. An input terminal of the inverter INV0 receives and inverts an enable signal ENB to generate an inverted enable signal EN. The enable signal ENB may be a low active signal, and the inverted enable signal EN may be a high active signal.

The oscillator 210 is configured to receive the inverted enable signal EN, and to generate clock signals CK and CKB which are periodic signals having opposite phases when the inverted enable signal EN is at a high logic level. In this embodiment, when the inverted enable signal EN is at a low logic level, the oscillator 210 may stop oscillating the clock signals CK and CKB, and maintain the clock signals CK and CKB at different logic levels respectively.

The logic circuit 220 is coupled to the oscillator 210. The logic circuit 220 is configured to respectively perform logic operations on the enable signal ENB and the clock signals CK and CKB, thereby respectively generating clock signals CLK and CLKB. In this embodiment, the logic circuit 220 includes a NOR gate NO2, a NAND gate NA2, and inverters INV1 and INV2. The NOR gate NO2 receives the enable signal ENB and the clock signal CK. An output terminal of the NOR gate NO2 is coupled to an input terminal of the inverter INV1. The NOR gate NO2 and the inverter INV1 generate the clock signal CLK based on a logic OR operation result of the enable signal ENB and the clock signal CK. In addition, the NAND gate NA2 receives the inverted enable signal EN and the clock signal CKB. An output terminal of the NAND gate NA2 is coupled to an input terminal of the inverter INV2. The NAND gate NA2 and the inverter INV2 generate the clock signal CLKB based on a logic AND operation result of the inverted enable signal EN and the clock signal CKB.

According to this embodiment, the logic circuit 220 is configured such that, when the enable signal ENB is at a low logic level, the clock signals CLK and CLKB may be periodic signals having opposite phases. When the enable signal ENB is at a high logic level, the clock signal CLK may be maintained at a high logic voltage, and the clock signal CLKB may be maintained at a high logic voltage or maintained at a low logic voltage.

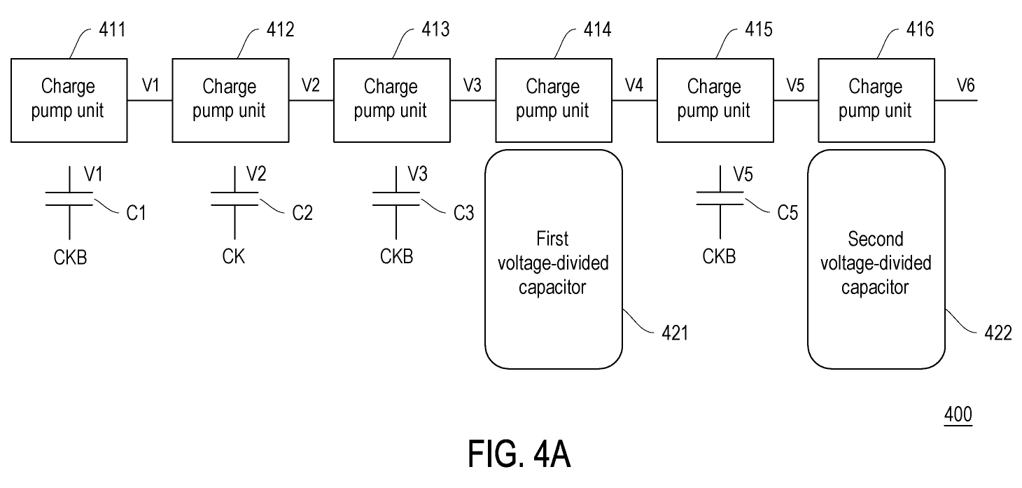

Reference is made to FIGS. 1, 2, 3A, and 3B at the same time, wherein FIGS. 3A and 3B are waveform diagrams of an operation of the voltage generating device of an embodiment of the disclosure. As shown in FIG. 3A, when the charge pump circuit is in an enabled state, the enable signal ENB may be at a low logic level. In response thereto, the logic circuit 220 of the clock signal generator 200 may generate the clock signals CLK and CLKB which are periodic signals having opposite phases. In response thereto, a control voltage Vpreq which is also a periodic signal may be generated by the level shifter 131 in the bias generator 130 and may oscillate between a second preceding-stage boosted voltage VA+1 (or a boosted voltage V2) and a reference ground voltage VSS synchronously with the clock signal CLK. In response thereto, the boosted voltage VJ may oscillate between the boosted voltage VJ and a reference voltage VCC synchronously with the clock signal CLKB.

Here, an example is given in which a second terminal of the capacitor CA2 receives the clock signal CLKB, and a first terminal of the transistor MN receives the reference voltage VCC. During a period from time point T1 to T2, according to the clock signal CLK at a high logic level, the control voltage Vpreq is at a high voltage value (for example, the second preceding-stage boosted voltage VA+1), and the clock signal CLKB is at a low voltage value. The transistor MN may be turned on, and the capacitor CA2 may be charged to cause the bias voltage VQ to rise to equal the reference voltage VCC. Then, during a period from time point T2 to T3, according to the clock signal CLK at a low logic level, the control voltage Vpreq is at a low voltage value (for example, the reference ground voltage VSS), the transistor MN is turned off, but based on the charged capacitor CA2, the clock signal CLKB may rise to a high voltage value, and the bias voltage VQ may be boosted to a high voltage value greater than the reference voltage VCC.

According to this embodiment, in a process in which the charge pump circuit 100 generates the boosted voltage VN, the bias voltage VQ may oscillate up and down between the reference voltage VCC and a high voltage value greater than the reference voltage VCC following a corresponding boosted voltage VJ. Therefore, a voltage difference between two terminals of the capacitor CA1 may be less than the boosted voltage VJ. In addition, the bias voltage VQ may oscillate synchronously with a voltage of the clock signal CLKB. Therefore, a voltage difference between two terminals of the capacitor CA2 may also be less than the boosted voltage VJ. In other words, the bias voltage VQ may be less than the boosted voltage VJ and greater than the reference ground voltage VSS. Thereby, during an enabled period of the charge pump circuit 100, the capacitors CA1 and CA2 may not bear a high voltage difference, which helps to improve a service life of the capacitors CA1 and CA2.

As shown in FIG. 3B, in this embodiment, when the charge pump circuit 100 is in a disabled state, the enable signal ENB may be at a high logic level. In response thereto (as at time point T4), the clock signal CLK may be maintained at the high logic level, and the clock signal CLKB may be maintained at the low logic level. In response thereto, the level shifter 131 may correspondingly generate the control voltage Vpreq maintained at the second preceding-stage boosted voltage VA+1, and cause the bias voltage VQ to decrease to equal the reference voltage VCC through turning on the transistor MN. In response thereto, the boosted voltage is maintained at a voltage greater than the reference voltage VCC. At this time, two terminals of the capacitor CA1 respectively receive the boosted voltage VJ and the bias voltage VQ. Two terminals of the capacitor CA2 respectively receive the bias voltage VQ and the reference ground voltage VSS. That is, during the disabled period of the charge pump circuit 100, the capacitors CA1 and CA2 likewise do not bear a high voltage difference, which helps to improve the service life of the capacitors CA1 and CA2.

In addition, in another unshown embodiment, the logic circuit 220 may be configured to generate the clock signal CLKB maintained at a high logic level when the charge pump circuit 100 is in the disabled state.

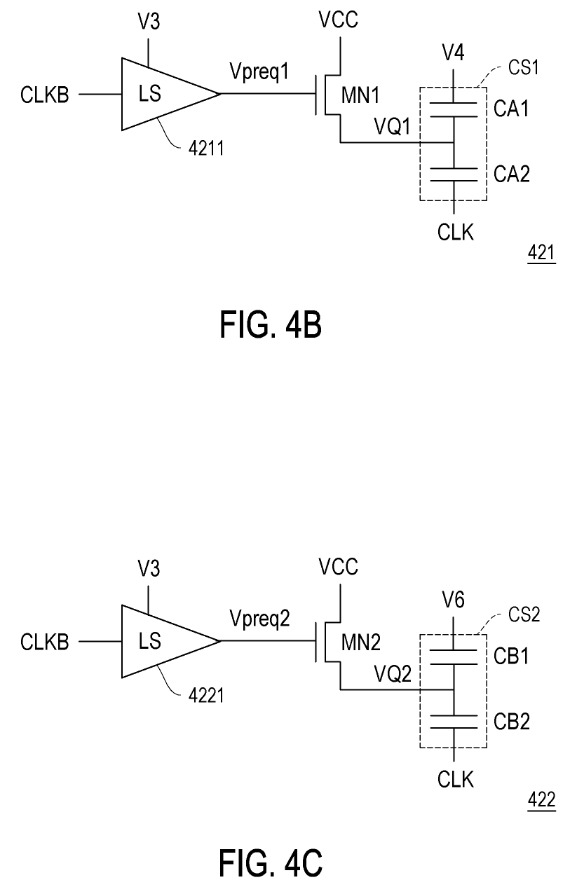

It should be noted that the disclosure does not limit a number of the voltage-divided capacitors. The following describes another embodiment of a charge pump circuit 400 of the disclosure with reference to FIGS. 4A, 4B, and 4C. The charge pump circuit 400 includes multiple stages of charge pump units (six stages in this embodiment, namely charge pump units 411 to 416, but the disclosure is not limited thereto), a plurality of capacitors C1, C2, C3, C5, a first voltage-divided capacitor 421, and a second voltage-divided capacitor 422. The charge pump units 411 to 416 are sequentially coupled in series, and respectively generate sequentially increased boosted voltages V1 to V6 by performing charge pump operations. The capacitors C1, C2, C3, and C5 are respectively coupled to output terminals of the charge pump units 411, 412, 413, and 415 to respectively receive the boosted voltages V1, V2, V3, and V5. The first voltage-divided capacitor 421 and the second voltage-divided capacitor 422 are respectively coupled to output terminals of the charge pump units 414 and 416 to respectively receive the boosted voltages V4 and V6.

As shown in FIG. 4B, the first voltage-divided capacitor 421 includes a level shifter 4211, a transistor MN1, and a capacitor string CS1 composed of capacitors CA1 and CA2. In this embodiment, a voltage received by the level shifter 4211 is greater than a voltage received by a first terminal of the transistor MN1. For example, the level shifter 4211 generates a control voltage Vpreq1 based on the boosted voltage V3 by shifting a voltage value of the clock signal CLKB. The level shifter 4211 provides the control voltage Vpreq1 to a control terminal of the transistor MN1. A first terminal of the transistor MN1 receives the reference voltage VCC. It should be noted that the above voltages received by the level shifter 4211 and the first terminal of the transistor MN1 are merely one example, and the disclosure is not limited thereto. For example, in some embodiments not illustrated, when the first terminal of the transistor MN1 is configured to receive the reference voltage VCC, the level shifter 4211 may be configured to generate the control voltage Vpreq1 based on the boosted voltage V2. In other embodiments, when the first terminal of the transistor MN1 is configured to receive the boosted voltage V2, the level shifter 4211 may be configured to generate the control voltage Vpreq1 based on the boosted voltage V3.

In this embodiment, a first terminal of the capacitor CA1 receives the boosted voltage V4, and a second terminal of the capacitor CA1 receives a bias voltage VQ1. Two terminals of the capacitor CA2 respectively receive the bias voltage VQ1 and the clock signal CLK. The transistor MN1 may generate the bias voltage VQ1 according to the control voltage Vpreq1, thereby causing a voltage difference between two terminals of each of the capacitors CA1 and CA2 to be less than the boosted voltage V4, in order to improve the service life of the capacitors CA1 and CA2.

As shown in FIG. 4C, the second voltage-divided capacitor 422 includes a level shifter 4221, a transistor MN2, and a capacitor string CS2 composed of capacitors CB1 and CB2. A voltage received by the level shifter 4221 is greater than a voltage received by a first terminal of the transistor MN2. For example, in this embodiment, the level shifter 4221 generates a control voltage Vpreq2 based on the boosted voltage V3 by shifting a voltage value of the clock signal CLKB. The level shifter 4221 provides the control voltage Vpreq2 to a control terminal of the transistor MN2. A first terminal of the transistor MN2 receives the reference voltage VCC.

In addition, a first terminal of the capacitor CB1 receives the boosted voltage V6, and a second terminal of the capacitor CB1 receives a bias voltage VQ2. Two terminals of the capacitor CB2 respectively receive the bias voltage VQ2 and the clock signal CLK. The transistor MN2 may generate the bias voltage VQ2 according to the control voltage Vpreq2, thereby reducing a voltage difference between two terminals of each of the capacitors CB1 and CB2, and effectively improving the service life of the capacitors CB1 and CB2. However, in some unshown embodiments, the bias voltage VQ2 may be greater than the bias voltage VQ1.

It is worth mentioning that, in a preferred embodiment, a preceding-stage capacitor (for example, the capacitor C1) in the charge pump circuits 100 and 400 may be a transistor capacitor having a low voltage tolerance or a silicon oxide-silicon nitride-silicon oxide (ONO) capacitor. An intermediate-stage capacitor (for example, the capacitor C2 in FIG. 1 or the capacitors C2 and C3 in FIG. 4A) in the charge pump circuits 100 and 400 may be an ONO capacitor. A later-stage charge pump unit (for example, any one or any combination of 11J, 414 to 416) in the charge pump circuits 100 and 400 may be coupled to a voltage-divided capacitor composed of a transistor capacitor having a low voltage tolerance, an ONO capacitor, a transistor capacitor having a high voltage tolerance, or a combination thereof. Thereby, compared with a case where capacitors in the charge pump circuit are entirely fabricated using transistor capacitors having a high voltage tolerance, this embodiment may have a smaller volume, which is beneficial to miniaturization of the charge pump circuit.

For example, regarding the capacitor string CS1, the capacitor CA1 may be an ONO capacitor, and the capacitor CA2 may be a transistor capacitor having a low voltage tolerance or an ONO capacitor. Regarding the capacitor string CS2, since the capacitor string CS2 receives the boosted voltage V6 having a relatively high voltage value, the capacitor CB1 therein may be a transistor capacitor having a high voltage tolerance, and the capacitor CB2 therein may be an ONO capacitor.

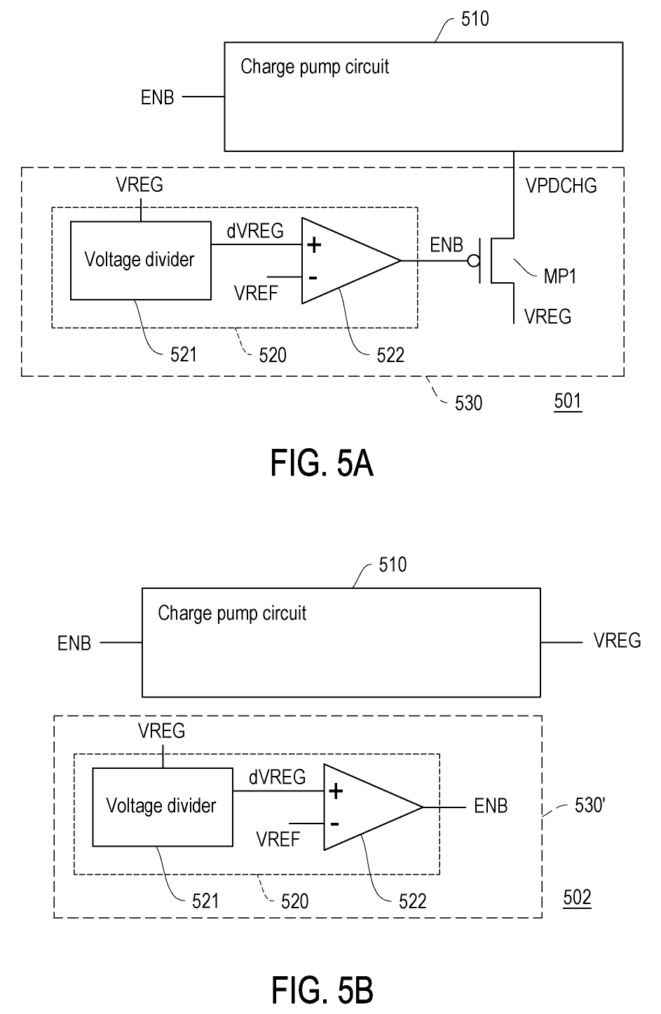

Reference is made to FIGS. 5A and 5B, wherein FIGS. 5A and 5B respectively illustrate schematic diagrams of voltage generating devices of different embodiments of the disclosure. In FIG. 5A, a voltage generating device 501 may be configured to generate a programming voltage VREG, so as to perform a programming operation on a memory cell in, for example, a flash memory. The voltage generating device 501 includes a charge pump circuit 510 and a voltage regulator 530. The charge pump circuit 510 may generate a plurality of boosted voltages and may provide a highest one of the boosted voltages to generate an output boosted voltage VPDCHG. Details of the charge pump circuit 510 have been mentioned in the above embodiments and are thus not repeated here. In this embodiment, the voltage regulator 530 may include an enable signal generator 520 and a transistor MP1.

A control terminal of the transistor MP1 receives an enable signal ENB. A first terminal of the transistor MP1 receives the output boosted voltage VPDCHG. A second terminal of the transistor MP1 is configured to provide the programming voltage VREG. The enable signal generator 520 may include a voltage divider 521 and a comparator 522. The voltage divider 521 is configured to divide the programming voltage VREG to generate a divided voltage dVREG. The comparator 522 is configured to compare the divided voltage dVREG and a reference voltage VREF, and to generate the enable signal ENB according to a comparison result.

In detail, when the divided voltage dVREG generated by the voltage divider 521 is greater than or equal to the reference voltage VREF, the comparator 522 may generate the enable signal ENB having a logic value of 1, so that the transistor MP1 is turned off and the charge pump circuit 510 is disabled. When the divided voltage dVREG is less than the reference voltage VREF, the comparator 522 may generate the enable signal ENB having a logic value of 0, so that the transistor MP1 is turned on and the charge pump circuit 510 is enabled.

Different from the embodiment of FIG. 5A, in a voltage generating device 502 shown in FIG. 5B, a transistor MP1 is not disposed in a voltage regulator 530’. An output boosted voltage generated by the charge pump circuit 510 (for example, the highest boosted voltage) may be directly used as the programming voltage VREG.

In summary, the voltage generating device and the charge pump circuit thereof of the disclosure couple an output terminal of part (preferably later-stage) of the charge pump units to a voltage-divided capacitor, and apply a specific bias voltage to the voltage-divided capacitor. This way, a voltage difference between two terminals of each capacitor in the voltage-divided capacitor may be effectively reduced, thereby avoiding a situation in which the two terminals of the capacitor bear a high voltage difference for a long time and cause a reduction in service life. As such, the service life of the voltage generating device and the charge pump circuit thereof may be improved, achieving the requirement of green semiconductors.

What is claimed is:

1. A charge pump circuit, comprising:
a plurality of charge pump units coupled in series, comprising a first charge pump unit and a second charge pump unit, wherein the first charge pump unit is configured to generate a first boosted voltage, and the second charge pump unit is configured to generate a second boosted voltage;
a first capacitor, coupled between the first boosted voltage and a first clock signal; and
a voltage-divided capacitor, coupled between the second boosted voltage and a second clock signal and receiving a bias voltage, wherein the bias voltage is less than the second boosted voltage and greater than a reference ground voltage.

2. The charge pump circuit according to claim 1, wherein the voltage-divided capacitor comprises:
a capacitor string, comprising a second capacitor and a third capacitor coupled in series, wherein the second capacitor is coupled between the second boosted voltage and the bias voltage, and the third capacitor is coupled between the bias voltage and the second clock signal.

3. The charge pump circuit according to claim 2, wherein the voltage-divided capacitor further comprises:
a bias generator, coupled to a bias node between the second capacitor and the third capacitor, wherein the bias generator is configured to provide the bias voltage to the bias node.

4. The charge pump circuit according to claim 2, wherein the second capacitor is a silicon oxide-silicon nitride-silicon oxide capacitor or a transistor capacitor having a high voltage tolerance, and the third capacitor is a transistor capacitor having a low voltage tolerance or a silicon oxide-silicon nitride-silicon oxide capacitor.

5. The charge pump circuit according to claim 3, wherein the bias generator comprises:
a level shifter, receiving the second clock signal and a first input voltage, and performing a voltage shifting operation on the second clock signal based on the first input voltage to generate a control voltage; and
a transistor, wherein a control terminal of the transistor is coupled to the level shifter to receive the control voltage, a first terminal of the transistor receives a second input voltage greater than or equal to a reference voltage, and a second terminal of the transistor is coupled to the bias node to provide the bias voltage, wherein the first input voltage is greater than the second input voltage and less than the second boosted voltage.

6. The charge pump circuit according to claim 1, comprising M of the first charge pump units and N-M of the second charge pump units, and comprising M of the first capacitors and N-M of the voltage-divided capacitors, wherein N is a positive integer greater than or equal to 2, and M is a positive integer less than N.

7. The charge pump circuit according to claim 6, wherein M is greater than N-M.

8. The charge pump circuit according to claim 1, wherein the first boosted voltage is less than the second boosted voltage.

9. The charge pump circuit according to claim 1, further comprising:
a clock signal generator, configured to generate the first clock signal, and to generate the second clock signal according to an enable signal and the first clock signal, wherein the enable signal is configured to disable or enable the charge pump circuit.

10. The charge pump circuit according to claim 9, wherein the clock signal generator comprises:
an oscillator, configured to generate the first clock signal and a first complementary clock signal having an opposite phase with respect to the first clock signal; and
a logic circuit, coupled to the oscillator, and performing a logic operation on the enable signal , the first clock signal, and the first complementary clock signal to generate the second clock signal and a second complementary clock signal having an opposite phase with respect to the second clock signal.

11. The charge pump circuit according to claim 10, wherein in response to the enable signal being configured to disable the charge pump circuit, the logic circuit is configured to maintain the second clock signal and the second complementary clock signal at a first logic value and a second logic value respectively.

12. The charge pump circuit according to claim 10, wherein in response to the enable signal being configured to enable the charge pump circuit, the logic circuit is configured such that the second clock signal and the second complementary clock signal are two periodic signals having opposite phases.

13. A voltage generating device, comprising:
the charge pump circuit according to any one of claims claim 1, configured to provide an output boosted voltage; and
an enable signal generator, coupled to the charge pump circuit, and configured to generate an enable signal configured to disable or enable the charge pump circuit according to a comparison result between the output boosted voltage and a reference voltage.

14. The voltage generating device according to claim 13, wherein the charge pump circuit further comprises:
a clock signal generator, configured to generate the first clock signal, and to generate the second clock signal according to the enable signal and the first clock signal.

15. The voltage generating device according to claim 14, wherein the clock signal generator comprises:
an oscillator, configured to generate the first clock signal and the first complementary clock signal; and
a logic circuit, coupled to the oscillator, and performing a logic operation on the enable signal and the first clock signal and the first complementary clock signal to generate the second clock signal and the second complementary clock signal.

16. The voltage generating device according to claim 15, wherein in response to the enable signal being configured to disable the charge pump circuit, the logic circuit is configured to maintain the second clock signal and the second complementary clock signal at a first logic value and a second logic value respectively.

17. The voltage generating device according to claim 15, wherein in response to the enable signal being configured to enable the charge pump circuit, the logic circuit is configured such that the second clock signal and the second complementary clock signal are two periodic signals having opposite phases.

18. The charge pump circuit according to claim 3, wherein the bias voltage is configured to oscillate synchronously with the second clock signal.

19. The charge pump circuit according to claim 3, wherein, when the charge pump circuit is disabled, the bias generator is configured to cause the bias voltage to decrease to a reference voltage.

20. The charge pump circuit according to claim 1, wherein the voltage-divided capacitor is coupled to an output terminal of a later-stage charge pump unit.
